(19) United States
(12) Patent Application Publication
(10) Pub. No.: US 2011/0085188 A1
(43) Pub. Date: Apr. 14, 2011

(54) IMAGE FORMATION DEVICE AND IMAGE FORMATION METHOD

(75) Inventor: Emiko Matsuoka, Shizuoka-ken (JP)

(73) Assignees: KABUSHIKI KAISHA TOSHIBA, Minato-ku, Tokyo (JP); TOSHIBA TEC KABUSHIKI KAISHA, Shinagawa-ku, Tokyo (JP)

(21) Appl. No.: 12/861,957

(22) Filed: Aug. 24, 2010

Related U.S. Application Data
(60) Provisional application No. 61/249,663, filed on Oct. 8, 2009.

(30) Foreign Application Priority Data
Jul. 1, 2010 (JP) 2010-150690

(51) Int. Cl. G06F 15/00

(52) U.S. Cl. 358/1.9

(57) ABSTRACT

An image formation device includes an image reading unit, a control unit, and a displaying unit. The image reading unit reads a document according to a scan parameter to obtain an image data having a first data size. The control unit controls changing the first data size to the second data size due to change of the scan parameter, and calculates the second data size based on the changed scan parameter. The displaying unit displays the second data size and a preview of image based on the second data size.

### CROSS-REFERENCE TO RELATED APPLICATION

This application is based upon and claims the benefit of priority from: U.S. provisional application 61/249,663, filed on Oct. 8, 2009, the entire contents of which are incorporated herein by reference.

This application is also based upon and claims the benefit of priority from the Japanese Patent Application No. 2010-150690, filed on Jul. 1, 2010, the entire contents of which are incorporated herein by reference.

### FIELD

Embodiments described herein relate generally to an image formation device and an image formation method.

### BACKGROUND

An image formation device stores an image after reading a document and transmits the image as being attached to a mail. However, when the image formation device includes a memory having small size, the size of an image file is to be limited.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a block diagram showing a configuration of an image formation device according to a first embodiment;

FIG. 2 is a flow chart explaining an image formation method;

FIG. 3 shows an example of a window displaying a preview of an image and data size on a displaying unit;

FIG. 4 shows an example of a window displaying a select of resolution on the display unit;

FIG. 5 shows an example of a window displaying a preview of an image and data size on a displaying unit after changing resolution;

FIG. 6 is a diagram showing an array of pixels in an image to be scanned;

FIG. 7A is a diagram showing an array of pixels in the image before changing the resolution;

FIG. 7B is a diagram showing an array of pixels in the image after changing the resolution to that of ½;

FIG. 8 is a flow chart explaining an operation for changing the resolution to that of ½;

FIG. 9A is a diagram showing an array of pixels in the image before changing the resolution;

FIG. 9B is a diagram showing an array of pixels in the image after changing the resolution to that of ⅔;

FIG. 10 is a flow chart explaining an operation for changing the resolution to that of ⅔;

FIG. 11 shows an example of a window displaying a select of resolution and a select of color on the display unit according to a second embodiment;

FIG. 12 shows an example of a window displaying a select of color on the display unit; and

FIG. 13 shows an example of a window displaying a preview on the display unit according to a third embodiment.

### DETAILED DESCRIPTION

Embodiments according to the invention will be hereinafter described with reference to the drawings.

According to one aspect of the invention, an image formation device includes an image reading unit to read a document according to a scan parameter to obtain an image data having a first data size; a control unit to control changing the first data size to the second data size due to change of the scan parameter, and calculate the second data size based on the changed scan parameter; and a displaying unit to display the second data size and a preview of image based on the second data size.

According to another aspect of the invention, an image formation device includes means for reading a document according to a scan parameter to obtain an image data having a first data size; means for controlling changing the first data size to the second data size due to change of the scan parameter; means for calculating the second data size based on the changed scan parameter; and means for displaying the second data size and a preview of image based on the second data size.

According to another aspect of the invention, an image formation method includes reading a document according to a scan parameter to obtain an image data having a first data size; controlling changing the first data size to the second data size due to change of the scan parameter; calculating the second data size based on the changed scan parameter; and displaying the second data size and a preview of image based on the second data size.

### Description of the First Embodiment

In the first embodiment, when a document is read as image data, an image formation device calculates provisional data size of the read image data, and then, displays the provisional data size and a preview of the image based on the provisional data size at a displaying unit. A user verifies the data size and the image preview and changes image resolution so that the data size of the read image is to be desired data size.

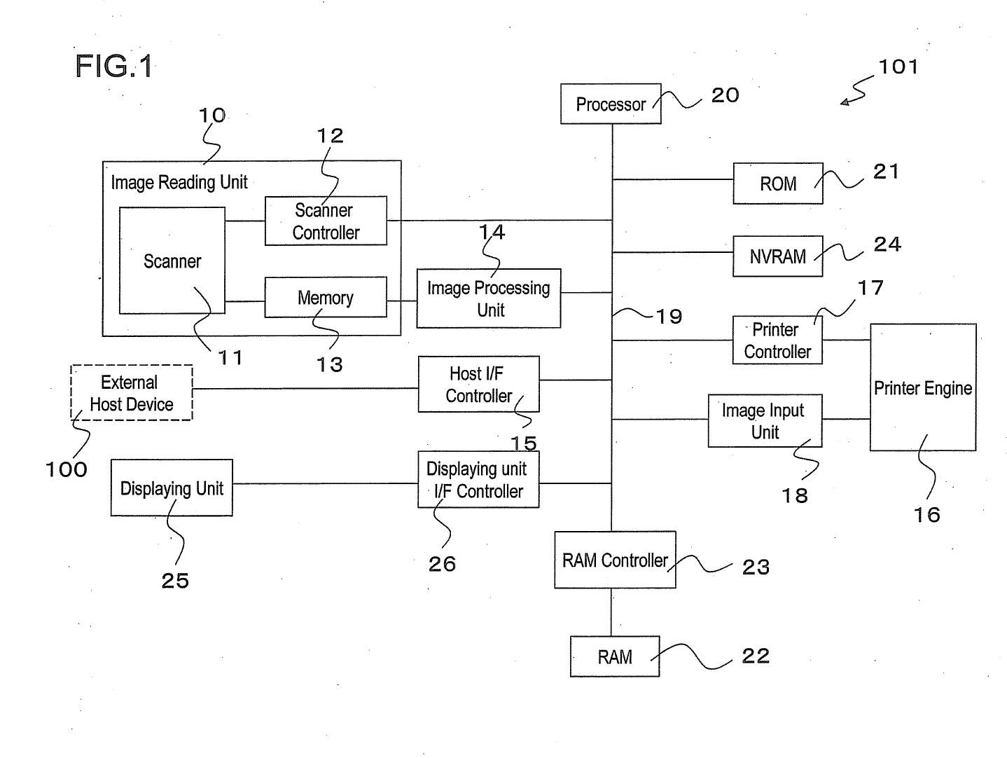

FIG. 1 is a block diagram showing the configuration of an image formation device 101. The image formation device 101 performs a copying function, a printing function and a scanning function as basic functions. The image formation device 101 includes a scanner 11, a scanner controller 12, a memory 13, an image processing unit 14, a host interface (I/F) controller 15, a printer engine 16, a printer controller 17, an image input unit 18, a processor 20, a read only memory (ROM) 21, a random access memory (RAM) 22, a RAM controller 23, a non-volatile RAM (NVRAM) 24, a displaying unit 25 and a displaying unit interface (I/F) controller 26. The respective components are mutually connected via a bus 19.

The scanner 11, the scanner controller 12 and the memory 13 operate as an image reading unit 10 to supply an image to the image formation device 101 in the copying function and the scanning function. The scanner 11 reads a document as color image data (i.e., multi-values image data) or monochrome image data by optically scanning a document surface. The scanner controller 12 controls the scanner 11. The memory 13 stores the color image data or the monochrome image data read by the scanner 11.

The image processing unit 14 performs a digital signal process on the image data stored in the memory 13.

The host I/F controller 15 supplies the image data to the image formation device 101 in the printing function. The host I/F controller 15 receives print data (i.e., code data such as character codes to create image data, or image data) from an external host device 100. For example, the external host device 100 is a client computer (PC) or a portable electronic device. There may be two or more external host devices 100. The image formation device 101 and the external host device 100 are connected via the host I/F controller 15 with local connection such as IEEE 1284 and USB, or wired or wireless network connection, for example.

The printer engine 16, the printer controller 17 and the image input unit 18 output image data in the copying function, the scanning function and the print function. The printer engine 16 forms image data on a printing medium by utilizing an image-forming method such as a laser method, an LED method and an ink-jet method. The printer controller 17 controls the printer engine 16. The image input unit 18 inputs image data to the printer engine 16.

A processor 20 (i.e., a control unit) controls each component of the image formation device 101 via the bus 19. Programs to be executed by the processor 20 are stored in the ROM 21. The processor 20 performs calculation of data size of the image data of the document read by the image reading unit 10 and making a change of the data size. Here, the processing performance may be enhanced by mounting plural processors 20.

The RAM 22 is utilized to temporally store processing data to be used by each component including the processor 20 via the RAM controller 23. The image data is stored in the RAM 22, for example. Here, a memory may be included in addition to the RAM 22.

The NVRAM 24 is a non-volatile memory and stores intrinsic information of the image formation device 101.

The displaying unit 25 is a user interface (UI) to display device operation. The displaying unit 25 may be a touch button to display operation of the image formation device 101 or an indicator (i.e., an indicator such as LED and LCD, and a speaker) to indicate operational status. In the first embodiment, the displaying unit 25 displays data size of image data and an image preview based on the data size. The displaying unit I/F controller 26 manages data input/output between the displaying unit 25 and other components.

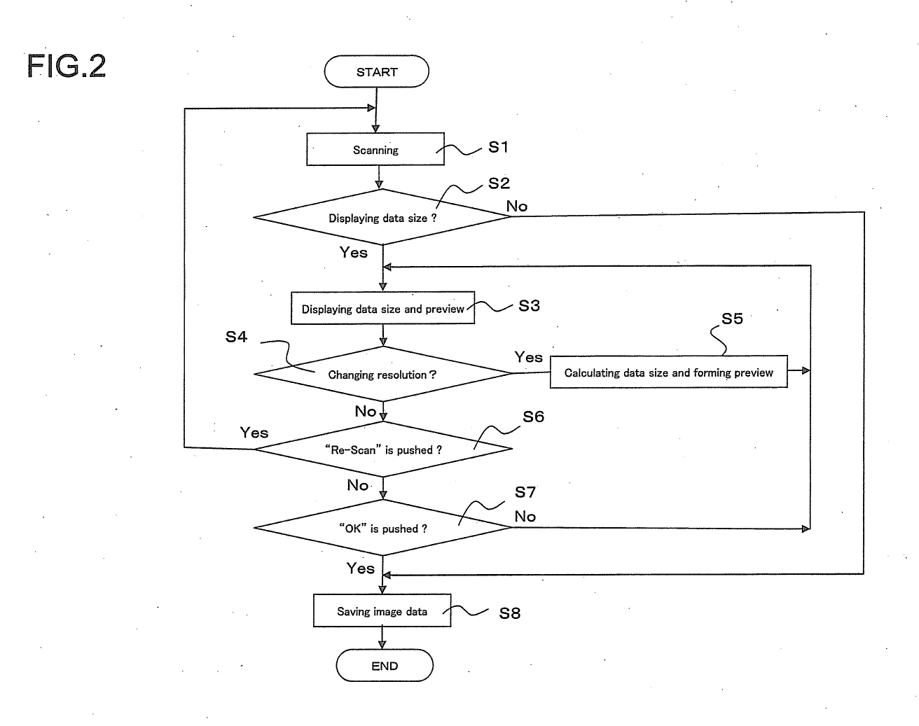

Next, an image formation method in the image formation device 101 will be described with reference to FIG. 2. FIG. 2 is a flowchart to describe the image formation method according to the first embodiment. In S1, the scanner 11 of the image formation device 101 obtains image data by scanning a document and outputs to the memory 13 to be stored (S1). Resolution and a file format for scanning is normally set at default but can be changed. Next, in S2, it is set whether or not the data size of the image data is to be displayed (S2). The setting is performed on the displaying unit 25 of the image formation device 101. In the case that the data size is not to be displayed (“No” in S2), the image formation device 101 does not perform a process to change resolution and display a preview. Then, in S8, the image data is stored in the RAM 22 of the image formation device 101 or a server (not shown) (S8). On the other hand, in the case that the data size is to be displayed (“Yes” in S2), the displaying unit 25 displays the data size of the image data (i.e., the first data size) and the image preview based on the first data size (S3).

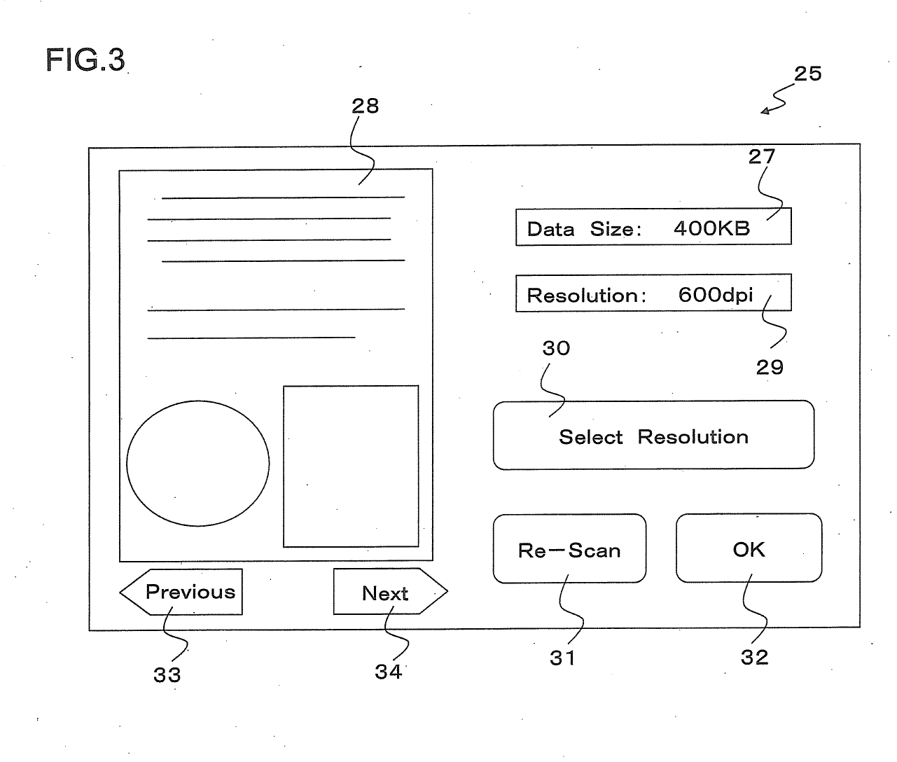

FIG. 3 shows a display example of the data size and the image data preview on the displaying unit 25. The displaying unit 25 displays “Data Size” 27 of the image data, “Preview” 28, “Resolution” 29 being set, a “Select Resolution” button 30, a “Re-scan” button 31, an “OK” button 32, a “Previous” button 33 and a “Next” button 34.

When the data size is determined not to be desirable as verifying “Data Size” 27 on the displaying unit 25, a user presses the “Select Resolution” button 30 to change “Resolution” 29. When the user determines that “Data size” 27 is larger than desired data size, for example, “Resolution” 29 (i.e., 600 dpi) is changed to 300 dpi with the “Select Resolution” button 30.

The user presses the “Re-scan” button 31 to perform re-scanning. Further, the user presses the “OK” button 32 to determine setting. The user presses the “Previous” button 33 to shift “Preview” 28 to the previous page. The user presses the “Next” button 34 to shift “Preview” 28 to the next page.

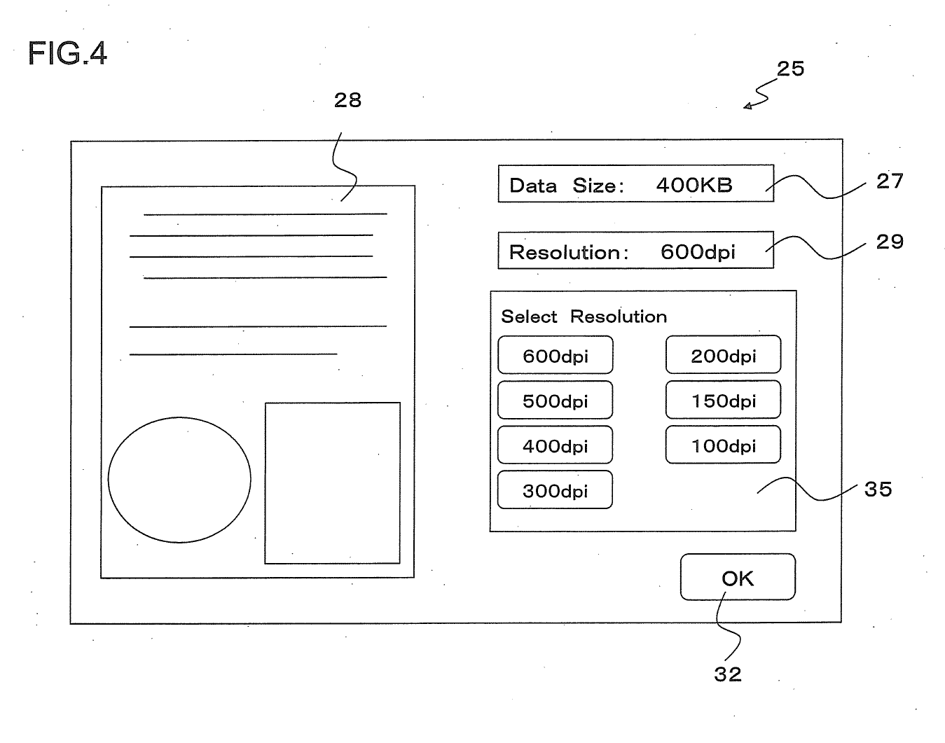

As described above, when the user verifies “Data size” 27 and presses the “Select Resolution” button 30 to change “Resolution” 29, the displaying unit 25 displays “Resolution Selecting Unit” 35 as shown in FIG. 4, for example. In the example of FIG. 4, “Resolution Selecting Unit” 35 can select any resolution among 100 dpi, 150 dpi, 200 dpi, 300 dpi, 400 dpi, 500 dpi and 600 dpi. The user selects desired resolution, 300 dpi, for example, at “Resolution Selecting Unit” 35 and determines by pressing the “OK” button 32.

Resolution setting can be performed for each page of the image data. That is, even in the image data of one file having plural pages, the resolution may be 600 dpi or 300 dpi according to each page. Switching of pages is performed by pressing the “Previous” button 33 or the “Next” button 34.

In the flowchart of FIG. 2, when the resolution is to be changed (“Yes” in S4), the data size is calculated based on the changed resolution and “Preview” 28 of the image data is created based on the changed resolution in S5. Here, the calculation of the data size and the creation of the preview are hypothetically performed and the data size is not obtained by actually performing scanning. Subsequently, returning to S3, the calculated data size and the image preview based on the calculated data size are displayed on the displaying unit 25. The processor 20 (i.e., the controller) controls the change of image resolution at the time of reading a document with the image reading unit 10 in S4 and the hypothetic data size calculation and preview creation in S5. The data size calculation and image preview creation will be described below.

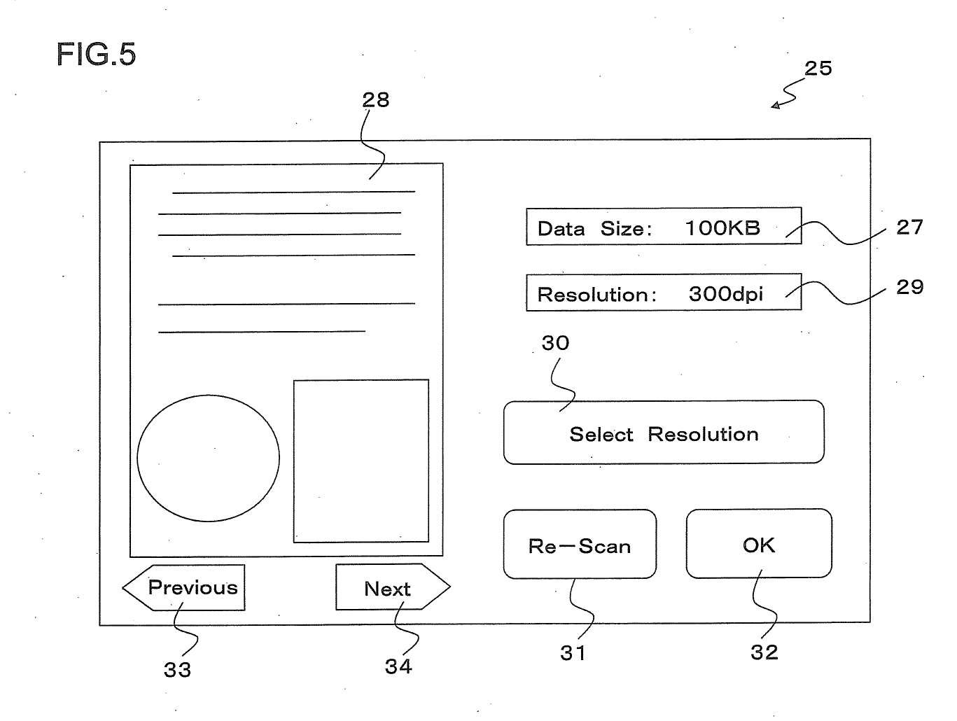

FIG. 5 shows a display example of the data size and image preview on the displaying unit 25 after “Resolution” 29 is changed. Compared to the display example before the resolution change of FIG. 3, “Resolution” 29 is changed from 600 dpi to 300 dpi in the display example after the resolution change of FIG. 5. Corresponding to resolution decrease, “Data Size” 27 is decreased from 400 KB to 100 KB. “Data Size” 27 (i.e., 100 KB) after changing of “Resolution” 29 indicates a hypothetically calculated value.

In the flowchart of FIG. 2, when “Data Size” 27 calculated in S5 after resolution change and display of “Preview” 28 are satisfactory for the user (“No” in S4), the processor 20 determines whether or not the “Re-scan” button 31 is pressed (S6). In the case that “Resolution” 29 has been changed (“Yes” in S4) up to the process, re-scanning requires to be performed in a state that “Resolution” 29 is changed (“Yes” in S6). Then, returning to S1, re-scanning is performed. In the case that “Resolution” 29 has not been changed up to the process, re-scanning does not require to be performed (“No” in S6). Then, proceeding to S7, the processor 20 determines whether or not the “OK” button 32 is pressed (S7). In the case that the “OK” button 32 is pressed (“Yes” in S7), the image is stored in the RAM 22 of the image formation device 101 or in the server (S8). Alternately, it is also possible to transmit scanned image data being attached to a mail without storing the image data (i.e., skipping S8). Meanwhile, in the case that the “OK” button is not pressed in S7 (“No” in S7), the procedure returns to S3.

Next, a calculation method of the hypothetic data size will be described. The data size after changing of “Resolution” 29 is acquired by following Equation (1).

File size after changing=((Changing resolution)²/(Scanned resolution)²)×(Scanned file size) (1)

Here, it is assumed that “Resolution” 29 is changed from 600 dpi to 300 dpi and the scanned data size is 400 KB, for example. A calculation result of 100 KB is acquired by substituting the above values into Equation (1). That is, when “Resolution” 29 is changed from 600 dpi to 300 dpi, the data size after changing is to be 100 KB.

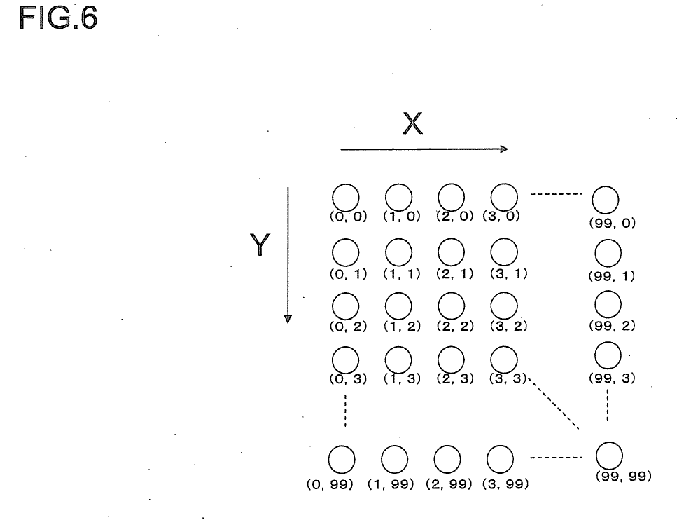

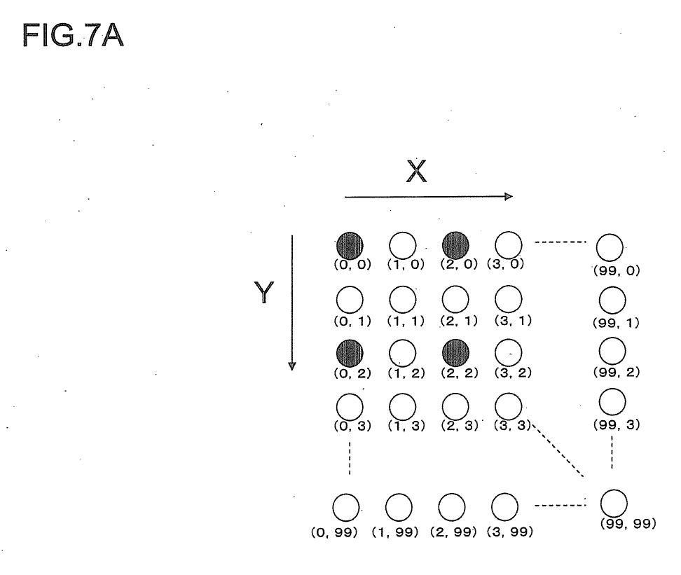

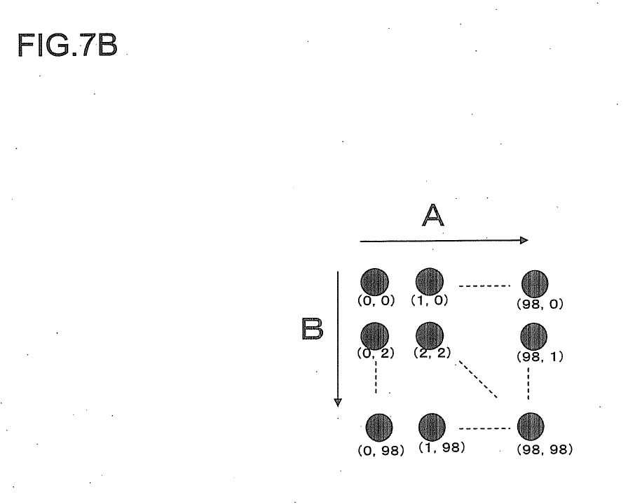

Next, a creation method of “Preview” 28 of the image data when “Resolution” 29 is changed to be half will be described with reference to FIGS. 6, 7A and 7B. Here, it is assumed that “Resolution” 29 is changed from 600 dpi to 300 dpi. FIG. 6 is a view showing a pixel array of an image scanned as 600 dpi. In FIG. 6, the pixel data is arranged in the X-direction and the Y-direction and the image having the array of 100×100 pixel data.

FIG. 7A is a view showing a pixel array of the image data before the resolution is changed (i.e., 600 dpi). The image data before resolution change is called scanned image data. In the scanned image data, the pixels are arranged in the X-axis direction and the Y-axis direction. The position of each pixel is assigned by variables (X, Y). FIG. 7B is a view showing a pixel array of the image data after the resolution is changed to be half (i.e., 300 dpi). The image data after resolution change is called image data A. In the image data A, pixels are arranged in the A-axis direction and the B-axis direction. The position of each pixel is assigned by variables (A, B). In the case that the pixel array in FIG. 6 is scan image data of 600 dpi and “Resolution” 29 is to be changed from 600 dpi to 300 dpi, it is only required to obtain black-filled pixels in FIG. 7A. When the black-filled pixel data in FIG. 7A is obtained and arranged, the image data after resolution change shown in FIG. 7B is formed.

In the first embodiment, when the resolution is changed, processing is performed sequentially from the left side for each column from the upper side. That is, processing is performed sequentially from the pixel at the left-upper side as pixels positioning at (0, 0), (0, 1), (0, 2), . . . in FIG. 7A. When processing on a pixel positioning at (0, 99) is completed, pixels at (1, 0), (1, 1), . . . on the right side by one column are sequentially processed. Ultimately, the processing is performed by a pixel at (99, 99). In the first embodiment, the starting point to process pixels is set to the pixel positioning at (0, 0) at the upper left side and the processing is performed sequentially by each column. However, not limited to the above, the process may be performed sequentially by each row and the starting point may be changed.

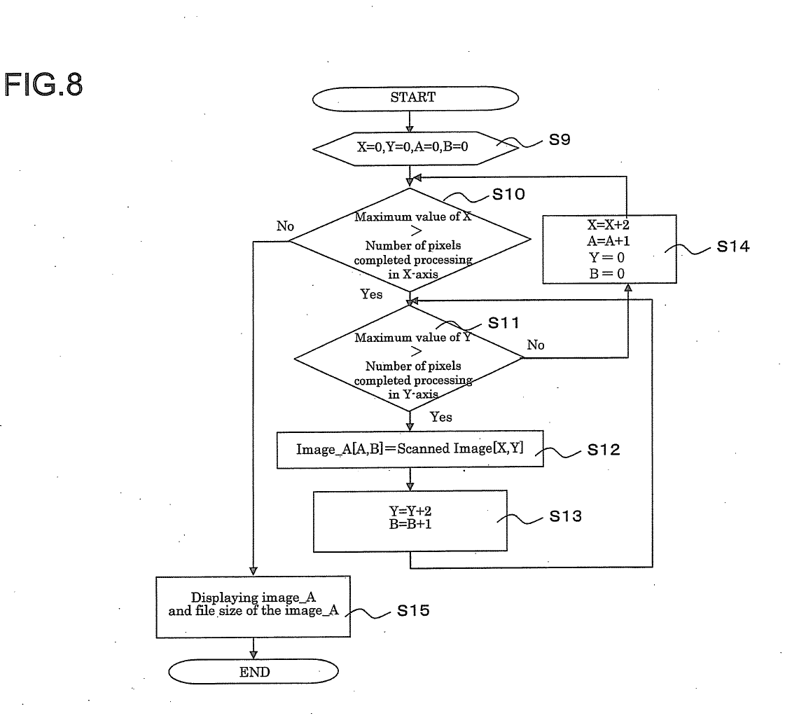

The operation to obtain the image data A as changing the resolution of the scanned image data to be half will be described with reference to a flowchart of FIG. 8. First, the variables (X, Y) of the scanned data and the variables (A, B) of the image data A are initialized in S9.

Next, in S10, it is determined whether or not the processed pixel count of the X-axis of the scanned image data is smaller than the maximum value in the X-axis being the lateral direction (i.e., the pixel count aligning in the X-axis direction). Here, the processed pixel count of the X-axis denotes the number of pixels having the process to change resolution completed in one row of the lateral direction (i.e., the X-axis direction) including the pixel assigned by the variables (X, Y). For example, assuming the pixel at (0, 0) in FIG. 7A is assigned, the processed pixel count of the X-axis is “0” being the same as X. In the case that the pixel at (2, 0) is assigned, the processed pixel count of the X-axis is “2” since the processing on the pixels positioning at (0, 0) and (1, 0) is completed. For example, with an array of 100×100 starting at (0, 0), the maximum value of X is to be 99.

Here, it is assumed that the variables (X, Y) assigns (0, 0). The processed pixel count of the X-axis is “0” being the same as X. Accordingly, in S10, the processed pixel count of the X-axis is determined as being smaller than the maximum value (i.e., 99) of X of the X-axis including the pixel assigned by the variables (X, Y) (“Yes” in S10). Next, it is determined whether or not a processed pixel count of the Y-axis being the same as Y is smaller than the maximum value (i.e., 99) of Y of the Y-axis (i.e., the vertical direction) including the pixel assigned by the variables (X, Y) (S11). Here, the processed pixel count of the Y-axis direction denotes the number of pixels having the process to change resolution completed in one column of the vertical direction (i.e., the Y-axis direction) including the pixel assigned by the variables (X, Y). For example, assuming the pixel at (0, 0) in FIG. 7A is assigned, the processed pixel count of the Y-axis is “0” being the same as Y. In the case that the pixel at (0, 2) is assigned, the processed pixel count of the Y-axis is “2” since the processing on the pixels at (0, 0) and (0, 1) is completed. For example, with an array of 100×100 starting at (0, 0), the maximum value of Y is to be 99 being similar to the maximum value of X.

Here, it is assumed that the variables (X, Y) assigns (0, 0). The processed pixel count of Y-axis is “0”. Accordingly, the processed pixel count of the Y-axis is determined as being smaller than the maximum value (i.e., 99) of Y of the vertical column (i.e., the Y-axis) including the pixel assigned by the variables (X, Y) (“Yes” in S11). Consequently, the pixels of the scanned image data are copied to the image data A (S12). Then, the pixel assignment position is moved and the process is performed on the next pixel (S13). “Y=Y+2” denotes that “Y” is shifted by two. Accordingly, “Y=0” results in “Y=2”. “B=B+1” denotes that “B” is shifted by one. Accordingly, “B=0” results in “B=1”.

Returning to S11 thereafter, the processes of S11, S12 and S13 are repeated until the processing on all pixels of the vertical column (i.e., the Y-axis direction) assigned by the variables (X, Y) is completed. After processing on all pixels of the vertical column (i.e., the Y-axis direction) is completed, the black-filled pixels of the first column of FIG. 7A are copied to the first column of FIG. 7B. When the processing in the Y-axis direction of the image is completed on the one assigned column of pixels (“No” in S11), the pixel assignment column is moved (S14). “X=X+2” denotes that “X” is shifted by two. Accordingly, “X=0” results in “X=2”. “A=A+1” denotes that “A” is shifted by one. Accordingly, “A=0” results in “A=1”. Here, it is to be “Y=B=0”. Accordingly, when the processing on the first column is completed, the position (2, 0) of FIG. 7A is to be assigned. Subsequently, the processes of S10 to S14 are repeated until the processing is completed on the entire scanned image.

When the processed pixel count of the X-axis becomes larger than the pixel count of the lateral row (i.e., the X-axis) including the pixel assigned by the variables (X, Y) (“No” in S10), it is determined that the processing on the entire image is completed. Then, “Preview” 28 of the image data A and “Data Size” 27 of the image data A are displayed on the displaying unit 25 (S15). In the above, the method to change “Resolution” 29 to be half is described. The method is adoptable when “Resolution” 29 is changed to be half not only in the case of changing from 600 dpi to 300 dpi.

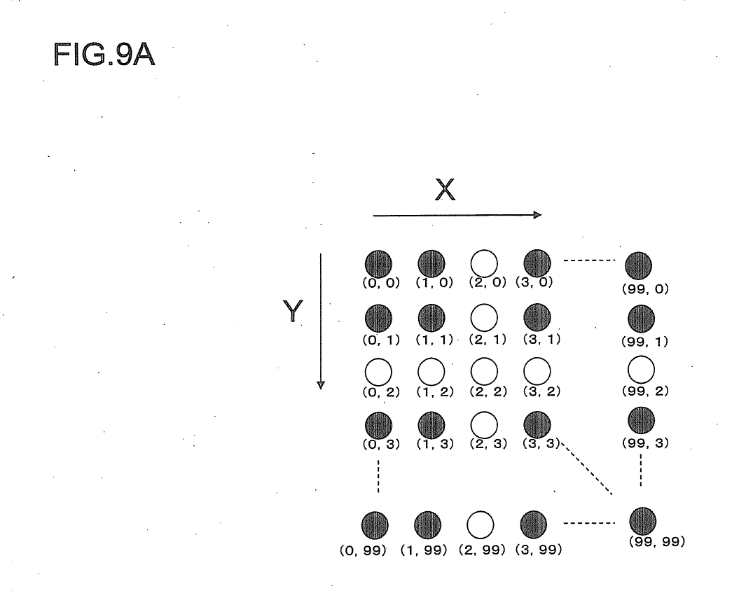

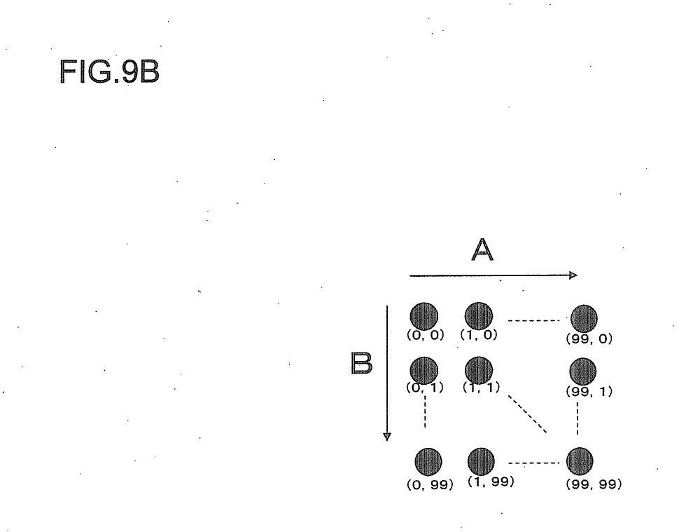

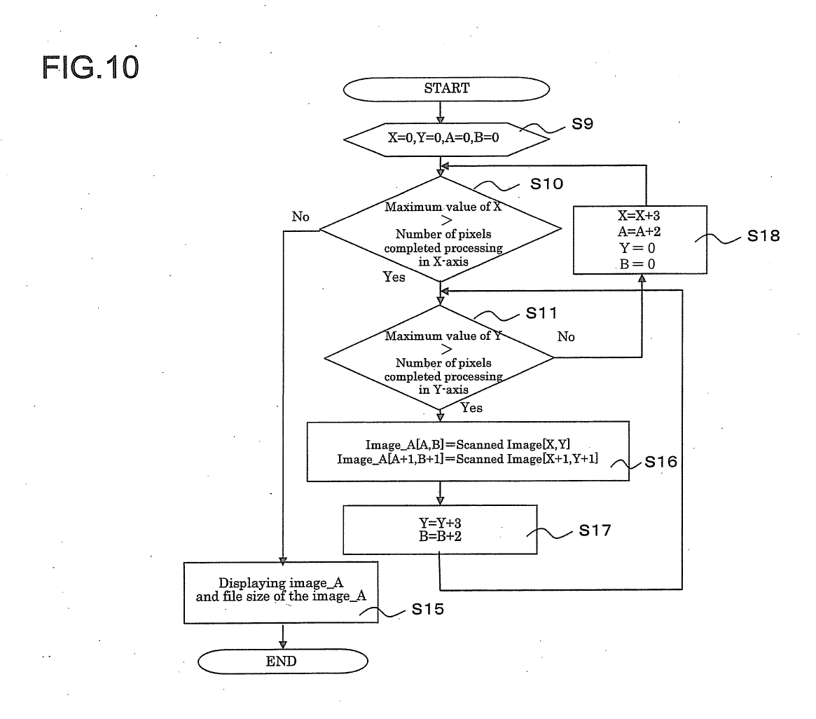

Next, a creation method of “Review” 28 of the image data when “Resolution” 29 is changed to be two thirds will be described with reference to FIGS. 9A, 9B and 10. Here, it is assumed that “Resolution” 29 is changed from 300 dpi to 200 dpi. FIG. 9A is a view showing a pixel array of the image data before the resolution is changed (i.e., 300 dpi). The image data before resolution change is called scanned image data. In the scanned image data, the pixels are arranged in the X-axis direction and the Y-axis direction. The position of each pixel is assigned by variables (X, Y). FIG. 9B is a view showing a pixel array of the image data after the resolution is changed to be two thirds (i.e. 200 dpi). The image data after resolution change is called image data A. In the image data A, pixels are arranged in the A-axis direction and the B-axis direction. The position of each pixel is assigned by variables (A, B). In the case that “Resolution” 29 is to be changed from 300 dpi to 200 dpi, it is only required to obtain black-filled pixels in FIG. 9A. When the black-filled pixel data in FIG. 9A is obtained and arranged, the image data after resolution change showed in FIG. 9B is formed. The above method to compress the scanned image data to be two third by obtaining two pixels out of three pixels is called the nearest neighbor method.

The operation to obtain the image data A as changing the resolution of the scanned image data to be two thirds will be described with reference to a flowchart of FIG. 10. Basically, the flowchart is formed to be similar to the process flow of FIG. 8. The difference exists in the positions and number of pixels to be copied to the image data A and the movement method of the variables (X, Y) and (A, B). In the following, the same numeral is given to the same portion as the description of FIG. 8 and detailed description will not be repeated.

First, the variables (X, Y) of the scanned image data and the variables (A, B) of the image data A are initialized in S9. Next, in S10, it is determined whether or not the processed pixel count of the X-axis being the same as X is smaller than the maximum value of the lateral row (i.e., the X-axis) including the pixel assigned by the variables (X, Y). Here, it is assumed that the pixel at (0, 0) is assigned, for example. The processed pixel count of the X-axis is “0” at that time. Accordingly, the processed pixel count of the X-axis is determined as being smaller than the maximum value of the X-axis including the pixel assigned by the variables (X, Y) (“Yes” in S10). Next, it is determined whether or not the processed pixel count of the Y-axis being the same as Y is smaller than the maximum value of the vertical column (i.e., the Y-axis) including the pixel assigned by the variables (X, Y) (S11).

For example, when the variables (X, Y) assigns (0, 0), the processed pixel count of the Y-axis is “0”. Accordingly, the processed pixel count of the Y-axis is determined as being smaller than the maximum value of the vertical column (i.e., the Y-axis) including the pixel assigned by the variables (X, Y) (“Yes” in S11). Consequently, the pixels of the scanned image data are copied to the image data A. That is, (X, Y) of the scanned image data is copied to (A, B) of the image data A. Further, (X+1, Y+1) of the scanned image data is copied to (A+1, B+1) of the image data A. Then, the pixel assignment position is moved and the process is performed on the next pixel (S17). “Y=Y+3” denotes that “Y” is shifted by three. Accordingly, “Y=0” results in “Y=3”. “B=B+2” denotes that “B” is shifted by two. Accordingly, “B=0” results in “B=2”.

Returning to S11 thereafter, the processes of S11, S16 and S17 are repeated until the processing on all pixels of one column in the vertical direction (i.e., the Y-axis direction) assigned by the variables (X, Y) is completed. After processing on all pixels of the vertical column (i.e., the Y-axis direction) is completed, the black-filled pixels of the first column of FIG. 9A are copied to the first column of FIG. 9B. When the processing in the Y-axis direction of the image is completed on the one column assigned by the variables (X, Y) (“No” in S11), the pixel assignment column is moved (S18). “X=X+3” denotes that “X” is shifted by three. Accordingly, “X=0” results in “X=3”. “A=A+2” denotes that “A” is shifted by two. Accordingly, “A=0” results in “A=2”. Here, it is to be “Y=B=0”. Accordingly, when the processing on the first column is completed, the position (2, 0) of FIG. 9A is to be assigned. Subsequently, the processes from S10 are repeated until the processing is completed on the entire scanned image. When the processing is completed on the entire image data (“No” in S10), “Preview” 28 of the image data A having decreased resolution and “Data Size” 27 of the image data A are displayed on the displaying unit 25 (S15).

The method to decrease the resolution to be two thirds may adopt not only the nearest neighbor method but also the straight-line approximation method. With the straight-line approximation method, image data is doubled and one pixel out of three pixels is obtained as a converted pixel from the doubled data. The straight-line approximation method is to obtain a value between adjacent numerals. In the case of data of “11, 34, 79”, for example, “22” (=11/2+34/2) is inserted between “11” and “34” in order to double the data. Similarly, “56” (=34/2+79/2) is inserted between “34” and “79”. In this manner, by obtaining one out of three from the doubled data, the data can be compressed to be two thirds. For example, “11” and “56” are obtained out of “11, 22, 34, 56, 79”.

In the above, the method to change “Resolution” 29 to be two thirds is described. The method is also adoptable when “Resolution” 29 is changed to be two thirds the case of being changed from 300 dpi to 200 dpi. In this case, it is only required to change the positions and number of pixels to be copied to the image data A and the movement method of the variables (X, Y) and (A, B) in S12 to S14 of FIG. 8.

According to the first embodiment, when reading image data with the image formation device 101, a user can change resolution so that data size of the image data is to be desirable for the user and verify the changed data size and preview of the changed image data at the displaying unit 25.

### Description of the Second Embodiment

In the second embodiment, when reading image data with the image formation device 101, a user changes resolution and color so that data size of the image data is to be desirable for the user and verify the changed data size and preview of the changed image data at the displaying unit. That is, in the second embodiment, color change is added to the first embodiment. By changing not only resolution but also color, the data size of the image data can be finely adjusted. Here, the same numeral is given to the same structural portion as the first embodiment and detailed description will not be repeated.

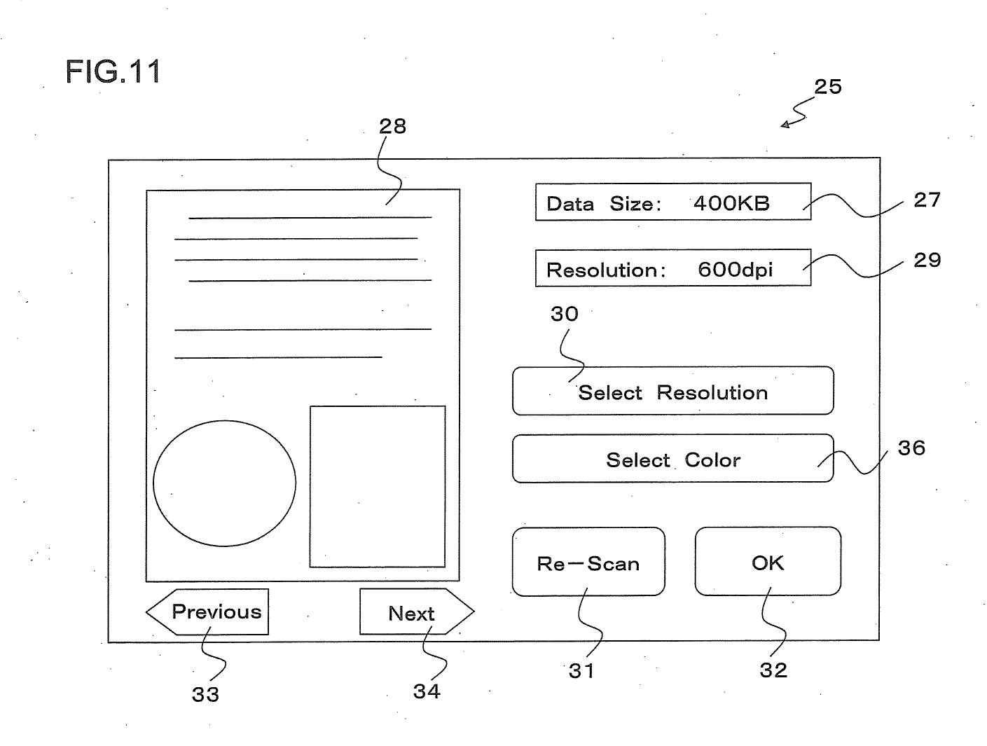

FIG. 11 is a view showing a display example of resolution change and color change on the displaying unit 25 according to the second embodiment. The displaying unit 25 displays “Data Size” 27 of the image data, “Preview” 28, “Resolution” 29 which is set, the “Select Resolution” button 30, a “Select Color” button 36, the “Re-scan” button 31, the “OK” button 32, the “Previous” button 33 and the “Next” button 34.

When the data size is determined not to be desirable as verifying “Data Size” 27, a user presses the “Select Color” button 36 to change “Data Size” 27. When the user determines that “Data Size” 27 is larger than desired data size, the mode is changed from color to monochrome, for example. In the second embodiment as well being similar to the first embodiment, it is possible to change only “Resolution” 29 by pressing the “Select Resolution” button 30. Further, it is also possible to change only the color/monochrome mode by pressing the “Select Color” button 36. Furthermore, it is also possible to change both “Resolution” 29 and color.

Here, the setting of the resolution and color can be performed for each page of the image data. That is, the image data of a file constituting with plural pages may have a page of resolution of 600 dpi, a page of resolution of 300 dpi, a color page and a monochrome page. Switching pages is performed by pressing the “Previous” button 33 or the “Next” button 34.

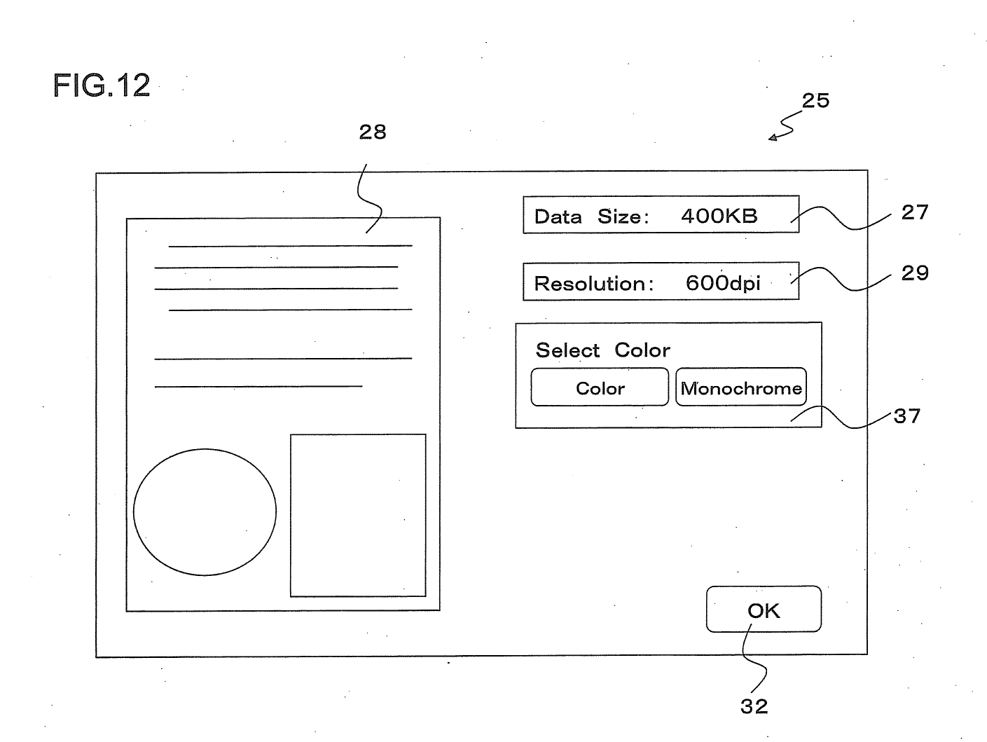

FIG. 12 is a view showing a display example of a color selecting unit on the displaying unit 25. When the user presses the “Select Color” button 36 at the display screen of FIG. 11, “Color Selecting Unit” 37 is displayed on the displaying unit 25 as shown in FIG. 12. The user can select color or monochrome with “Color Selecting Unit” 37 at the displaying unit 25 of FIG. 12. The processor 20 (i.e., the controller) controls the change of resolution and color of the image data when reading a document with a scanner and calculation of the hypothetic data size.

As a method of color conversion from color to monochrome, an intermediate value method or a weighted average method with an NTSC coefficient can be adopted, for example. The intermediate value method is a method of obtaining grayscale as calculating an intermediate value by adding the maximum value and the minimum value among three values of Red (R), Green (G) and Blue (B) and dividing by two. The three values of R, G, B are arbitrary integers between 0 and 255 inclusive. When the maximum value among the three values of R, G, B is denoted by max and the minimum value is denoted by min, the value Z after grayscale conversion is obtained by following Equation (2). Here, the range of Z is an integer between 0 and 255 inclusive.

Z=(max+min)/2 (2)

A round-off process is appropriately performed on Z corresponding to the processing system. An example will be described in the following. Respective values of R, G, B are assumed to be as (R, G, B)=(48, 170, 255). Accordingly, max=255 and min=48. By substituting the above values into Equation (2), Z is to be 151 (=(255+48)/2). In this manner, the value Z after grayscale conversion can be obtained as being 151.

Meanwhile, the weighted average method with an NTSC coefficient is a method of obtaining grayscale as calculating an average value by adding respectively weighted values of R, G, B and dividing by three. The three values of R, G, B are arbitrary integers between 0 and 255 inclusive. The value Z after grayscale conversion is obtained by following Equation (3). Here, the range of Z is an integer between 0 and 255 inclusive.

Z=(0.298912×R+0.586611×G+0.114478×B) (3)

Alternately, it is also possible to obtain the value Z after grayscale conversion by an approximation as Equation (4).

Z=(2×R+4×G+B)/7 (4)

Not limited to the intermediate value method and the weighted average method with an NTSC coefficient, another conversion method may be adopted as the conversion method from color to monochrome.

According to the second embodiment, when reading image data with the image formation device 101, a user can change resolution and color so that data size of the image data is to be desirable for the user and verify the changed data size and preview of the changed image data at the displaying unit 25.

### Description of the Third Embodiment

In the third embodiment, when reading image data with the image formation device 101, a user changes resolution so that data size of the image data is to be desirable for the user and verify at the displaying unit with thumbnail display having a number of previews of the changed image data placed. Here, the same numeral is given to the same structural portion as the first embodiment and detailed description will not be repeated.

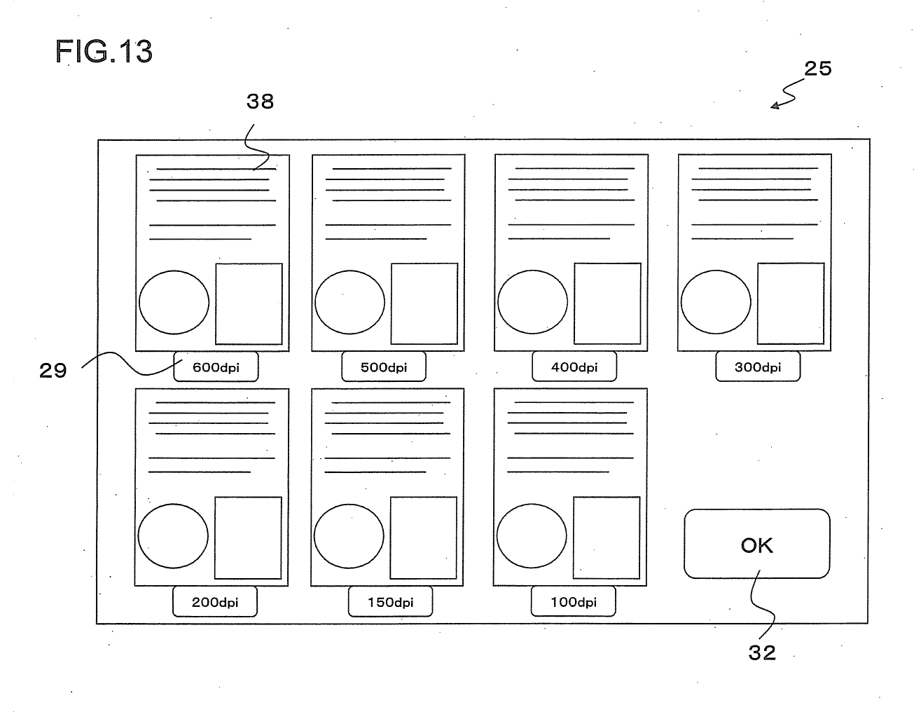

FIG. 13 is a view showing a display example displaying previews as thumbnails on the displaying unit 25. Each “Thumbnail” 38 is based on different “Resolution” 29. As shown in FIG. 13, a user can verify each “Thumbnail” 38 having different “Resolution” 29 at sight. The user selects “Thumbnail” 38 from a thumbnail list and presses the “OK” button 32. When specific “Thumbnail” 38 is selected, the selected “Thumbnail” 38 may be displayed as being enlarged.

According to the third embodiment, when reading image data with the image formation device 101, a user can change resolution so that data size of the image data is to be desirable for the user and verify the changed data size and preview of the changed image data with the thumbnails based on different resolution as sight. Then, the user can select an appropriate thumbnail from the list. In addition, by changing both resolution and color being similar to the second embodiment, adjustment of image data may be performed more finely.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and a entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image formation device, comprising:
an image reading unit to read a document according to a scan parameter to obtain an image data having a first data size;
a control unit to control changing the first data size to the second data size due to change of the scan parameter, and calculate the second data size based on the changed scan parameter; and
a displaying unit to display the second data size and a preview of image based on the second data size.

2. The image formation device of claim 1, wherein the scan parameter is resolution or color.

3. The image formation device of claim 1, wherein the scan parameter includes both resolution and color.

4. The image formation device of claim 1, wherein the displaying unit displays the first data size before displaying the second data size.

5. The image formation device of claim 4, wherein the displaying unit displays the resolution which is applied to read the document and available resolutions, with displaying the first data size.

6. The image formation device of claim 1, wherein the preview displayed on the displaying unit is a provisional preview based on the second data size.

7. The image formation device of claim 4, wherein the displaying unit displays the preview of the document read by the image reading unit, with displaying the first data size.

8. The image formation device of claim 1, wherein the displaying unit displays the preview of the document as thumbnail image.

9. The image formation device of claim 1, wherein the control unit controls changing the first data size to the second data size for each of pages.

10. The image formation device of claim 2, wherein the image reading unit reads the document again according to the changed resolution or the changed color.

11. The image formation device of claim 3, wherein the image reading unit reads the document again according to the changed resolution and the changed color.

12. An image formation device, comprising:
means for reading a document according to a scan parameter to obtain an image data having a first data size;
means for controlling changing the first data size to the second data size due to change of the scan parameter;
means for calculating the second data size based on the changed scan parameter; and
means for displaying the second data size and a preview of image based on the second data size.

13. An image formation method, comprising:
reading a document according to a scan parameter to obtain an image data having a first data size;
controlling changing the first data size to the second data size due to change of the scan parameter;
calculating the second data size based on the changed scan parameter; and
displaying the second data size and a preview of image based on the second data size.

14. The image formation method of claim 13, wherein the scan parameter is resolution or color.

15. The image formation method of claim 13, wherein the scan parameter includes both resolution and color.

16. The image formation method of claim 13, further comprising:
displaying the first data size before displaying the second data size.

17. The image formation method of claim 16, wherein the resolution which is applied to read the document and available resolutions is displayed with displaying the first data size.

18. The image formation method of claim 13, wherein the preview is a provisional preview based on the second data size.

19. The image formation method of claim 16, wherein the preview is displayed with displaying the first data size.

20. The image formation method of claim 13, wherein the preview is displayed as thumbnail image.
